(19) United States
(12) Patent Application Publication
(10) Pub. No.: US 2007/0267935 A1
(43) Pub. Date: Nov. 22, 2007

(54) Alternator rotor coil wire routing

(76) Inventors: Michael T. York, Pendleton, IN (US); LIoyd L. Ford, Anderson, IN (US)

Correspondence Address: CANTOR COLBURN, LLP, 55 GRIFFIN ROAD SOUTH, BLOOMFIELD, CT, 06002, US

(21) Appl. No.: 11/434,700

(22) Filed: May 16, 2006

(51) Int. Cl. H02K 9/06; H02K 11/00; H01R 39/08

(52) U.S. Cl. 310/263; 310/71; 310/62; 310/232

(57) ABSTRACT

Disclosed herein is a rotor assembly for an electric machine. The rotor assembly includes a shaft, at least one slip ring, a field coil, a first pole segment, and a wire retainer. The at least one slip ring is attached to the shaft. The field coil surrounds the shaft such that the field coil has one or more wire sections in electrical communication with the at least one slip ring. The first pole segment rotates with the shaft. And, the wire retainer is disposed between the field coil and the at least one slip ring such that the wire retainer includes at least one opening, disposed along an outer periphery of the pole segment, for routing the one or more wire sections.

### TECHNICAL FIELD

This application relates generally to an electrical apparatus. More specifically, this application relates to a rotor for an electric machine having an improved field coil wire routing.

### BACKGROUND OF THE INVENTION

Electric machines are found in virtually every motor vehicle manufactured today. These electric machines, also referred to as alternators, produce electricity necessary to power vehicle electrical accessories, as well as to charge a vehicle's battery. Electric machines must also provide the capability to produce electricity in sufficient quantities to power a vehicle's electrical system in a manner that is compatible with the vehicle electrical components. Furthermore, electrical loads for vehicles continue to escalate while, at the same time, the overall package size available for the electrical machine continues to shrink.

Electric machines generally include a stationary winding called a stator and a rotating field winding, including two pole segments, called a rotor. Currently, alternator rotor field coil wires require difficult and expensive manufacturing processes to securely retain the wires in proper position. Conventional electric machines require methods involving wire wrapping, heat staking, and the application of epoxy to securely retain the field coil wires in proper position. These methods are further limited by inadequate performance at higher rotation speeds (i.e. greater than 20,000 rpm).

Accordingly, there is a need to provide a robust support structure, which enhances field coil wire retention at higher rotation speeds while reducing cost and difficulty in the manufacturing and assembly processes.

### BRIEF SUMMARY OF THE INVENTION

Disclosed herein is a rotor assembly for an electric machine. The rotor assembly includes a shaft, at least one slip ring, a field coil, a first pole segment, and a wire retainer. The at least one slip ring is attached to the shaft. The field coil surrounds the shaft such that the field coil has one or more wire sections in electrical communication with the at least one slip ring. The first pole segment rotates with the shaft. And, the wire retainer is disposed between the field coil and the at least one slip ring such that the wire retainer includes at least one opening, disposed along an outer periphery of the pole segment, for routing the one or more wire sections.

Further disclosed herein is a rotor assembly for an electric machine. The rotor assembly includes a shaft, at least one slip ring, a field coil, a first pole segment, a wire retainer, and a single uninterrupted insulating sleeve. The at least one slip ring is attached to the shaft. The field coil surrounds the shaft such that the field coil has one or more wire sections in electrical communication with the at least one slip ring. The first pole segment rotates with the shaft. The wire retainer is disposed between the field coil and the at least one slip ring. And, the single uninterrupted insulating sleeve is disposed from the outer periphery of the pole segment to the at least one slip ring.

Yet further disclosed herein is a method for routing field coil wires of a rotor assembly. One or more wire sections are extended from the field coil. The wire sections are routed along one or more routing channels of a wire retainer. And, the wire sections are secured to one or more ribs disposed within the one or more routing channels.

### BRIEF DESCRIPTION OF THE DRAWINGS

Referring to the drawings wherein like elements are numbered alike in the several Figures:

FIG. 1 is a perspective view of an exemplary rotor assembly for use in accordance with an embodiment of the invention;

FIG. 2 is a perspective view of the rotor assembly illustrated in FIG. 1 further depicting wire routings;

FIG. 3 is a perspective view of the rotor assembly illustrated in FIG. 1 further depicting wire routings and a fan.

### DETAILED DESCRIPTION OF THE INVENTION

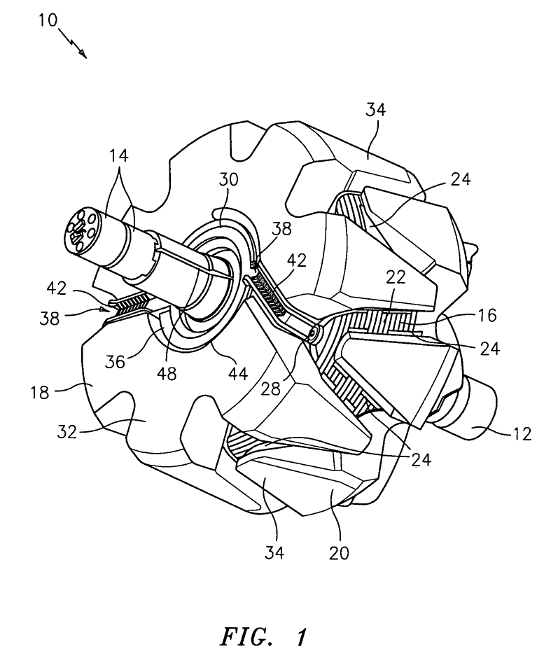

Referring to FIG. 1, an exemplary embodiment of a rotor assembly 10 for an electric machine that, for example, can be used in an automobile is illustrated. The rotor assembly 10 includes a shaft 12, a pair of slip rings 14, a field coil 16 surrounding a core (not shown), a first pole segment 18, and a second pole segment 20. The shaft 12 serves as a mounting surface for these components and defines a central axis about which the rotor assembly 10 rotates. The slip rings 14 provide an electrical connection between a source of electrical current and the field coil 16. The field coil 16, when energized, creates a magnetic field that saturates the surrounding first pole segment 18 and second pole segment 20. The disclosed routing of the electrical connection between the slip rings 14 and the field coil 16 provides many significant advantages over conventional configurations including improved durability and higher speed capability.

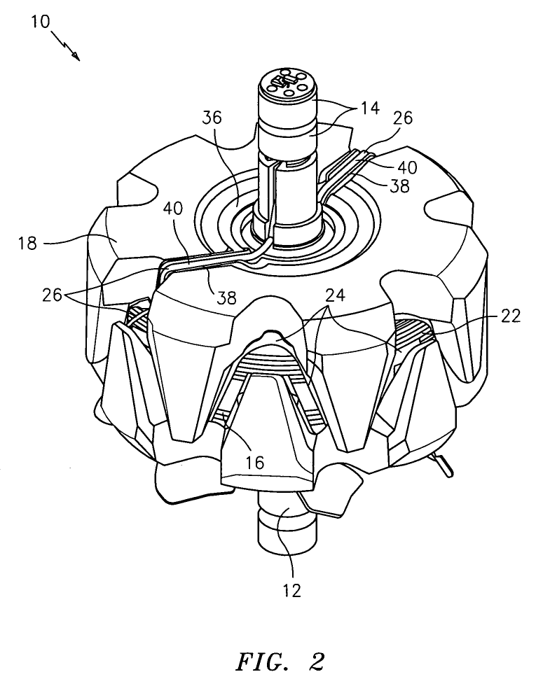

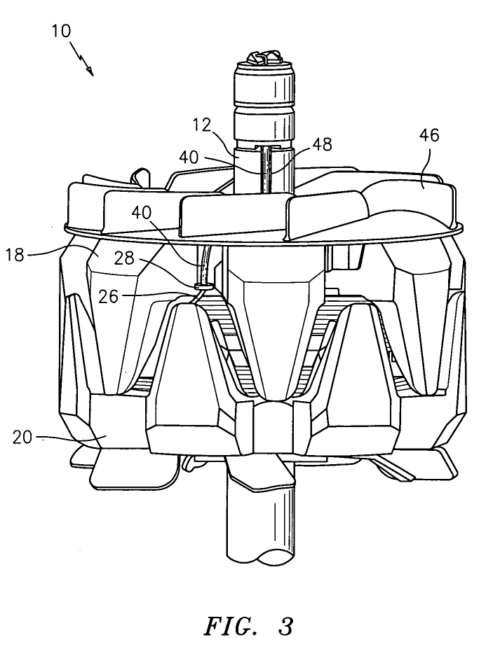

The field coil 16 comprises a plurality of turns of electrical wire 22 wound upon a bobbin 24. Wire sections 26 (illustrated in FIGS. 2 and 3) of electrical wire 22 are routed for electrical connection to the slip rings 14. Wire sections 26, after emerging from the field coil 16, are inserted through a pair of openings 28 of a wire retainer 30. The wire retainer 30 provides a routing path along an end face 32 of the first pole segment 18. The openings 28 of the wire retainer 30 are located at an outer periphery of the pole segment 18, which may be, for example, within recesses between a plurality of claw-shaped fingers 34 extending from the outer periphery of the pole segment 18. The openings 28 of the wire retainer 30 in one embodiment have a diameter slightly larger than the diameter of the wire sections 26 passing through it. The openings 28 of the wire retainer 30 may further be oriented to have their respective centerlines parallel to the shaft 12 central axis. This orientation provides for a change in direction of the wire sections 26 of approximately about ninety degrees which guides the wire sections 26 towards the end face 32 of the pole segment 18 and provides for increased field coil 16 wire retention. The disclosed opening configuration additionally minimizes the free length of the field coil 16 wire when compared to conventional configurations requiring the wire sections 26 to be wrapped around a portion of the bobbin.

The wire retainer 30 includes a generally annular body 36 and routing channels 38 which extend from the annular body towards an outer periphery of the first pole segment 18 and terminate at portions containing the openings 28. An alternative configuration will not include the openings 28 but instead will have channels substantially parallel to the central axis of the shaft 12. Additionally, the wire retainer may terminate with one portion having an opening 28 and the other portion containing the channel substantially parallel to the central axis of the shaft. Furthermore, it should also be noted that any combination of openings and/or channels is also envisioned. Wire retainer 30 is preferably made from an electrically insulating material, such as plastic for example. Wire sections 26 are positioned within the routing channels 38 of the retainer after they are passed through the openings 28, or through the channels substantially parallel to the central axis of the shaft 12, or through one opening 28 and through one channel as in the alternative wire retainer configurations discussed above. The wire sections 26 each further include a single insulating sleeve 40 (illustrated in FIGS. 2 and 3), surrounding the wire sections 26, at portions disposed between the openings 28 of the wire retainer 30 and the slip rings 14. The insulating sleeves 40 provide an insulating layer around the wire sections 26 which help prevent electrical short circuits between the wire sections 26 and contacting portions of the rotor assembly 10. The insulating sleeves 40 also assist in securing the wire sections 26 within the routing channels 38 by causing an interference engagement with a plurality of ribs 42, providing a locking feature, disposed along the routing channels 38. It is to be understood however that ribs 42 are not required. One alternative configuration does not exhibit ribs 42 at all but merely will have a routing channel width sufficient to cause an interference engagement with the insulating sleeve 40.

To further promote secure wire section position within the routing channels 38, a varnish may be applied to the insulating sleeves 40 in the portions of the insulating sleeves 40 disposed along the routing channels 38. The term varnish includes a process of bonding the wire sections 26 to the routing channels 38 by applying a bonding agent such as a thermal set varnish that is applied to the rotor by a trickle process in which the varnish is trickled onto the rotor assembly or by a dipping process in which the rotor assembly is dipped into a varnish pool.

The wire retainer 30 is preferably located in an axially recessed portion 44 of pole segment 18, such that extending routing channels 38 are flush or below end face 32 of pole segment 18. This facilitates attachment of a fan 46, if desired, to end face 32 of the pole segment 18. Such a fan 46 may be attached, for example, by projection or spot welding. In addition, fan 46 may be attached by press fitting a ring onto the shaft 12 that traps the fan 46 onto the end face 32 of the pole segment 18. It is to be understood however that the wire retainer 30 is not required to be located in an axially recessed portion 44 of the pole segment 18. One alternative configuration may have a fan that includes a complementary shape to accommodate the routing channels 38. Another alternative configuration may include a wire retainer not having routing channels 38 wherein the wire retainer is located on the end face 32 of the pole segment 18 and held in position by an adjacent fan having a shape capable of trapping the wire retainer against the end face 32 of the pole segment 18. Additionally, a varnish may be applied to the end face 32 of the pole segment 18. Yet another alternative configuration may not have a fan adjacent to the pole segment 18 at all.

The positioning of the wire sections 26 beyond the routing channels 38 includes routing the wire sections 26 through an axial groove 48 in shaft 12 for connection to slip rings 14. The disclosed configuration of the wire sections 26 routing between the slip rings 14 and the openings 28 in the wire retainer 30 allows for a single uninterrupted insulating sleeve 40 to be disposed around each of the wire sections 26 as opposed to conventional configurations requiring interrupted insulating sleeves 40 due to wire retaining methods that include wire wrapping, heat staking, and epoxy.

Additionally, the disclosed configuration having a pair of openings at ends of the wire retainer 30 acts as a positive stop for the insulating sleeves 40. The diameter of the openings 28 in the wire retainer 30 are smaller than the diameter of the insulating sleeves 40, which prevent the insulating sleeves 40 (and the wire sections 26) from moving due to centrifugal forces created during rotation of the rotor assembly 10. The positive stop also aids in manufacturing the part correctly by ensuring insulating sleeves 40 are positioned correctly on the wire sections 26.

Significant advantages in rotor assembly 10 failure prevention may be attained by the disclosed field coil 16 routing configuration. The field coil 16 routing configuration provides a robust support structure that minimizes difficult manufacturing processes and promotes lower cost assembly procedures.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A rotor assembly for an electric machine comprising:
a shaft;
at least one slip ring attached to the shaft;
a field coil surrounding the shaft wherein the field coil has one or more wire sections in electrical communication with the at least one slip ring;
a first pole segment rotatable with the shaft; and
a wire retainer disposed between the field coil and the at least one slip ring wherein the wire retainer includes at least one opening, disposed along an outer periphery of the pole segment, for routing the one or more wire sections.

2. The rotor assembly of claim 1 wherein the wire retainer is disposed within an axial recessed portion of the pole segment.

3. The rotor assembly of claim 1 wherein each of the one or more wire sections further comprise a single uninterrupted insulating sleeve between the at least one opening and the at least one slip ring.

4. The rotor assembly of claim 1 wherein the wire retainer further comprises one or more routing channels having a locking feature.

5. The rotor assembly of claim 4 wherein the locking feature is one or more ribs disposed within the routing channels.

6. The rotor assembly of claim 1 further comprising a fan disposed adjacent to the pole segment.

7. A rotor assembly for an electric machine comprising:
a shaft;
at least one slip ring attached to the shaft;
a field coil surrounding the shaft wherein the field coil has one or more wire sections in electrical communication with the at least one slip ring;
a first pole segment rotatable with the shaft;
a wire retainer disposed between the field coil and the at least one slip ring; and, a single uninterrupted insulating sleeve disposed from the outer periphery of the pole segment to the at least one slip ring.

8. The rotor assembly of claim 7 wherein the wire retainer further comprises one or more openings disposed along the outer periphery of the pole segment.

9. The rotor assembly of claim 8 wherein the one or more openings have a smaller diameter than the insulating sleeve.

10. The rotor assembly of claim 7 wherein the shaft further comprises an axial groove.

11. The rotor assembly of claim 7 further comprising a fan disposed adjacent to the pole segment.

12. A method for routing field coil wires of a rotor assembly, the method comprising:
extending one or more wire sections from the field coil;
routing the wire sections along one or more routing channels of a wire retainer; and
securing the wire sections to one or more ribs disposed within the one or more routing channels.

13. The method of claim 12 wherein the routing of the wire sections further includes routing the wire sections through one or more openings disposed at the ends of the routing channels.

14. The method of claim 12 wherein the securing of the wire leads further comprises varnishing the wire sections to one or more ribs.

15. The method of claim 12 wherein the securing of the wire leads further comprises disposing a fan adjacent to the wire retainer.
